(19) United States
(12) Patent Application Publication
(10) Pub. No.: US 2010/0201272 A1
(43) Pub. Date: Aug. 12, 2010

(54) Plasma generating system having nozzle with electrical biasing

(76) Inventor: Sang Hun Lee, San Ramon, CA (US)

Correspondence Address: JORDAN AND HAMBURG LLP, 122 EAST 42ND STREET, SUITE 4000, NEW YORK, NY, 10168, US

(21) Appl. No.: 12/322,909

(22) Filed: Feb. 9, 2009

(51) Int. Cl. H05H 1/46; B23K 9/00

(52) U.S. Cl. 315/111.21; 219/121.36

(57) ABSTRACT

The present invention provides a plasma generating system that includes: a microwave generator for generating microwave energy; a power supply connected to the microwave generator for providing power thereto; a microwave cavity; a waveguide operatively connected to the microwave cavity for transmitting microwave energy thereto; an isolator for dissipating microwave energy reflected from the microwave cavity; and at least one nozzle coupled to the microwave cavity. The nozzle includes: a housing having a generally cylindrical space formed therein, the space forming a gas flow passageway; a rod-shaped conductor disposed in the space and operative to transmit microwave energy along a surface thereof so that the microwave energy excites gas flowing through the space; and a biasing device for providing a bias potential between the rod-shaped conductor and a bias electrode structure wherein the bias electrode structure is offset in potential from ground.

### BACKGROUND OF THE INVENTION

1. Field of the Invention

The present invention relates to plasma generators, and more particularly to devices having a nozzle that discharges a plasma plume.

2. Discussion of the Related Art

In recent years, the progress on producing plasma by use of microwave energy has been increasing. Typically, a plasma producing system includes a device for generating microwave energy and a nozzle that receives the microwave energy to excite gas flowing through the nozzle into plasma. One of the difficulties in operating a conventional plasma producing system is providing an optimum condition for plasma ignition—a transition from the gas into the plasma. Several parameters, such as gas pressure, gas composition, nozzle geometry, nozzle impedance, material properties of nozzle components, intensity of microwave energy applied to the nozzle, and electrical potential between the ground and the portion where the microwave energy is focused, for instance, may affect the plasma ignition condition. The threshold intensity of the microwave energy for plasma ignition can be reduced if the electrical potential can be increased. Thus, there is a need for a nozzle that has a mechanism for increasing the electrical potential between the ground and the portion where the microwave energy is focused.

### SUMMARY OF THE INVENTION

According to one aspect of the present invention, a plasma generating system includes at least one nozzle. The nozzle includes: a housing having a generally cylindrical space formed therein, the space forming a gas flow passageway; a rod-shaped conductor disposed in the space and operative to transmit microwave energy along a surface thereof so that the microwave energy excites gas flowing through the space; and means for providing a bias potential between the rod-shaped conductor and the means.

According to another aspect of the present invention, a plasma generating system includes: a microwave generator for generating microwave energy; a power supply connected to the microwave generator for providing power thereto; a microwave cavity; a waveguide operatively connected to the microwave cavity for transmitting microwave energy thereto; an isolator for dissipating microwave energy reflected from the microwave cavity; and at least one nozzle coupled to the microwave cavity. The nozzle includes: a housing having a generally cylindrical space formed therein, the space forming a gas flow passageway; a rod-shaped conductor disposed in the space and operative to transmit microwave energy along a surface thereof so that the microwave energy excites gas flowing through the space; and means for providing a bias potential between the rod-shaped conductor and the means.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” language are not to be considered limited to equivalents of specific embodiments described herein.

### BRIEF DESCRIPTION OF THE DRAWINGS

FIG. 1 shows a schematic diagram of a plasma generating system in accordance with one embodiment of the present invention.

FIG. 2 shows an exploded view of a portion of the plasma generating system of FIG. 1.

FIG. 3 shows a side cross-sectional view of the portion of the plasma generating system of FIG. 2, taken along the line III-III.

FIG. 4 shows a plot of electrical potential between ground and a tip of a rod-shaped conductor of the nozzle of FIG. 1 as a function of time.

FIG. 5 shows a side cross-sectional view of a portion of a plasma generating system in accordance with another embodiment of the present invention.

FIG. 6 shows an exploded view of a portion of a plasma generating system in accordance with yet another embodiment of the present invention.

FIG. 7 shows a side cross-sectional view of the portion of the plasma generating system of FIG. 6, taken along the line VII-VII.

FIG. 8 shows a side cross-sectional view of a portion of a plasma generating system in accordance with still another embodiment of the present invention.

### DETAILED DESCRIPTION OF THE PREFERRED EMBODIMENTS

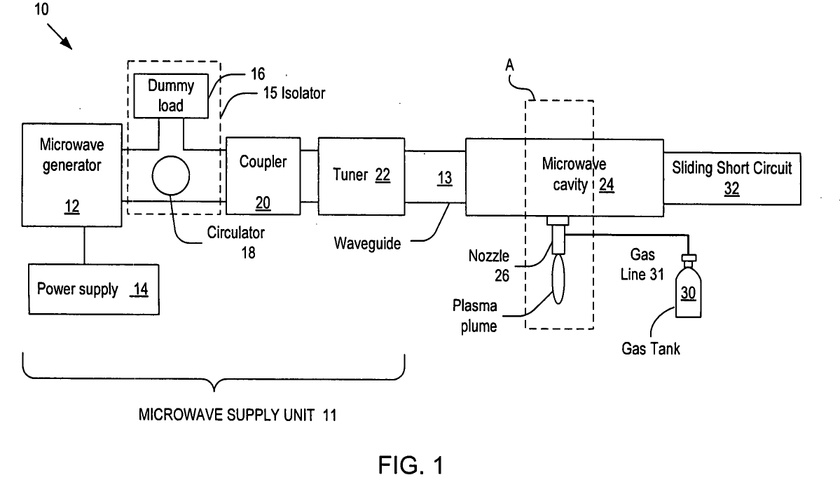

FIG. 1 shows a schematic diagram of a plasma generating system 10 in accordance with one embodiment of the present invention. As illustrated, the system 10 includes: a microwave cavity/waveguide 24; a microwave supply unit 11 for providing microwave energy to the microwave cavity 24 via a microwave waveguide 13; a nozzle 26 connected to the microwave cavity 24 and operative to receive microwave energy from the microwave cavity 24 and excite gas by use of the received microwave energy; and a sliding short circuit 32 disposed at the end of the microwave cavity 24. The gas stored in a gas tank 30 is provided to the nozzle 26 via a gas line 31 connected to the nozzle.

The microwave supply unit 11 provides microwave energy to the microwave cavity 24 and includes: a microwave generator 12 for generating microwaves; a power supply 14 for supplying power to the microwave generator 12; and an isolator 15 having a dummy load 16 for dissipating reflected microwave energy that propagates toward the microwave generator 12 and a circulator 18 for directing the reflected microwave energy to the dummy load 16.

The microwave supply unit 11 may further include a coupler 20 for measuring fluxes of the microwave energy; and a tuner 22 for reducing the microwave energy reflected from the sliding short circuit 32. The components of the microwave supply unit 11 shown in FIG. 1 are listed herein for exemplary purposes only. Also, it is possible to replace the microwave supply unit 11 with any other suitable system having the capability to provide microwave energy to the microwave cavity 24 without deviating from the spirit and scope of the present invention. Likewise, the sliding short circuit 32 may be replaced by a phase shifter that can be configured in the microwave supply unit 11. Typically, a phase shifter is mounted between the isolator 15 and the coupler 20.

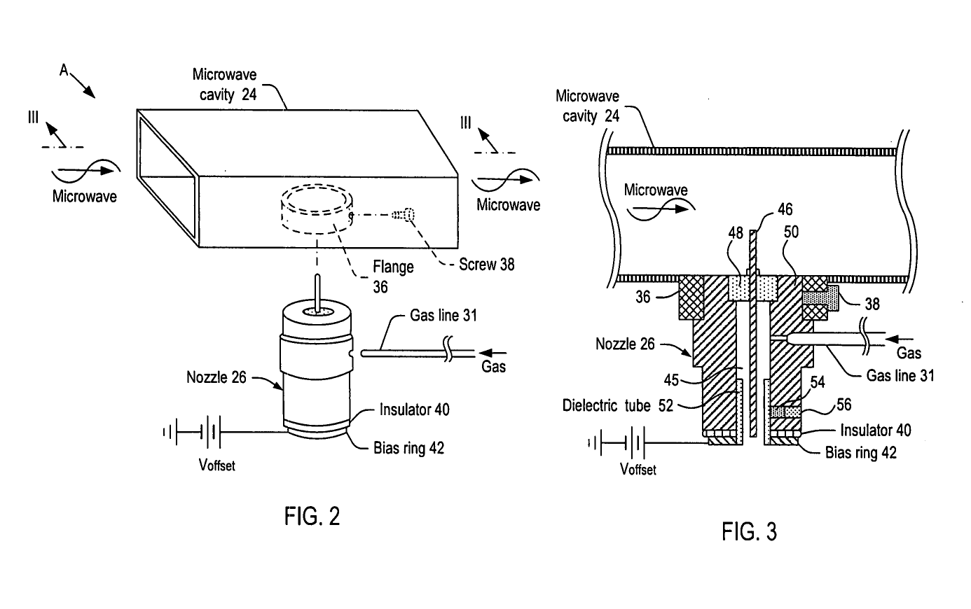

FIG. 2 shows an exploded view of a portion A of the plasma generating system 10 of FIG. 1. FIG. 3 shows a side cross-sectional view of the portion A of the plasma generating system 10, taken along the line III-III. As depicted, a ring-shaped flange 36 is affixed to the bottom surface of the microwave cavity 24 and the nozzle 26 is secured to the ring-shaped flange 36 by one or more suitable fasteners 38, such as screws.

The nozzle 26 includes a rod-shaped conductor 46; a housing or shield 50 formed of conducting material, such as metal, and having a generally cylindrical cavity/space 45 formed therein so that the space forms a gas flow passageway; an electrical insulator 48 disposed in the space and adapted to hold the rod-shaped conductor 46 relative to the shield 50; a bias ring 42 formed of conducting material, such as metal, and electrically biased by V_{offset} relative to the ground; and an insulator 40 having a generally ring shape and electrically insulating the bias ring 42 from the housing 50; a dielectric tube (such as quartz tube) 52; a spacer 54; and a fastener 56, such as a metal screw, for pushing the spacer 54 against the dielectric tube 52 to thereby secure the dielectric tube 52 to the housing 50. The spacer 54 is preferably formed of dielectric material, such as Teflon®.

A top portion (or, equivalently, proximal end portion) of the rod-shaped conductor 46 functions as an antenna to pick up microwave energy in the microwave cavity 24. The microwave energy captured by the rod-shaped conductor 46 flows along a surface thereof. Gas, supplied via a gas line 31, is injected into the space 45 and excited by the microwave energy flowing through the rod-shaped conductor 46. Typically, the plasma is formed at a bottom tip (or, equivalently, distal end) of the rod-shaped conductor 46. As such, the electrical potential between the bottom tip of the rod-shaped conductor 46 and the bias ring 42 affects the threshold condition of the plasma ignition.

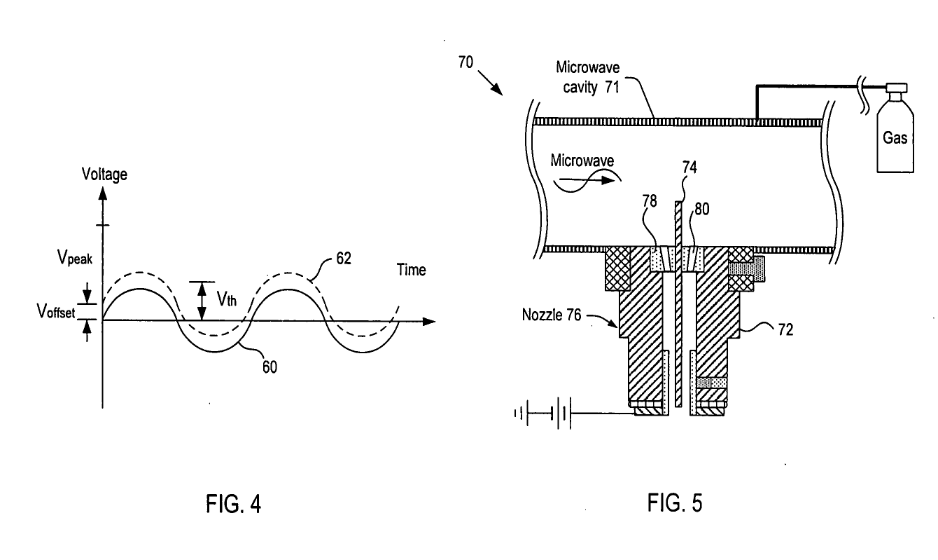

FIG. 4 shows a plot of the electrical potential between the bias ring 42 and the bottom tip of the rod-shaped conductor 46 as a function of time. The solid curve 60 represents the electrical potential between the bias ring 42 (or, equivalently biased component) and the bottom tip of the rod-shaped conductor 46 when V_{offset} is zero, i.e., the electrical potential curve 60 is due to only the microwave energy received by the top portion of the rod-shaped conductor 46 extending into the microwave cavity 24. The dotted curve 62 represents the electrical potential between the bias ring 42 and the bottom tip of the rod-shaped conductor 46 when V_{offset} is not zero. As depicted, the electrical potential curve 62 is shifted upwardly from the potential curve 60 by the V_{offset}, increasing the peak value, Vₚₑₐₖ. To ignite the plasma, the magnitude of Vₚₑₐₖ should be larger than a threshold potential, Vₜₕ, as shown in FIG. 4. As such, by increasing the V_{offset} applied to the bias ring 42, the intensity of microwave energy in the microwave cavity 24 required to ignite the plasma can be reduced.

Referring back to FIG. 3, V_{offset} can be provided by a DC power source. However, an AC power source can be also used as long as the peak value, Vₚₑₐₖ, of the resultant potential between the biased component and the bottom tip of the rod-shaped conductor is larger than the threshold potential, Vₜₕ. Depending on the type of plasma application, V_{offset} may be turned off or lowered after ignition.

As discussed above, to ignite plasma, the magnitude of Vₚₑₐₖ should be larger than a threshold potential. As such, the bias ring 42 may be negatively biased with respect to the ground to have the same beneficial effect on the plasma ignition. It is also noted that the field strength, which is Vₚₑₐₖ divided by the distance between the bottom tip of the rod-shaped conductor 46 and the bias ring 42, is another parameter that affects the plasma ignition. As such, the nozzle 26 may have a mechanism to move the rod-shaped conductor 46 relative to the housing 50 so that the bottom tip of the rod-shaped conductor 46 may be adjusted to maximize the field strength. More detailed information of the mechanism to move the rod-shaped conductor 46 can be found in U.S. patent application Ser. No. 12/291,646, entitled “Plasma generating system having tunable plasma nozzle,” filed on Nov. 12, 2008, which is herein incorporated by reference in its entirety. For brevity, the nozzle 26 having a mechanism to move the rod-shaped conductor 46 similar to the mechanism described in the copending U.S. patent application Ser. No. 12/291,646 is not shown in the present document.

FIG. 5 shows a side cross-sectional view of a portion of a plasma generating system 70 in accordance with another embodiment of the present invention wherein like parts are the same as those of the embodiment of FIG. 3 and functioning is the same except as follows. As depicted, the system 70 is similar to the system 10 of FIG. 3, with the difference in the gas injection system. In the system 70, the gas is supplied through a microwave cavity 71 and through holes 80 formed in electrical insulator 78, i.e., a housing/insulator 72 of a nozzle 76 does not have any gas injection hole. The through holes 80 may be angled relative to a longitudinal axis of a rod-shaped conductor 74 to impart a helical shaped flow direction around the rod-shaped conductor 74 to a gas passing along the through holes 80.

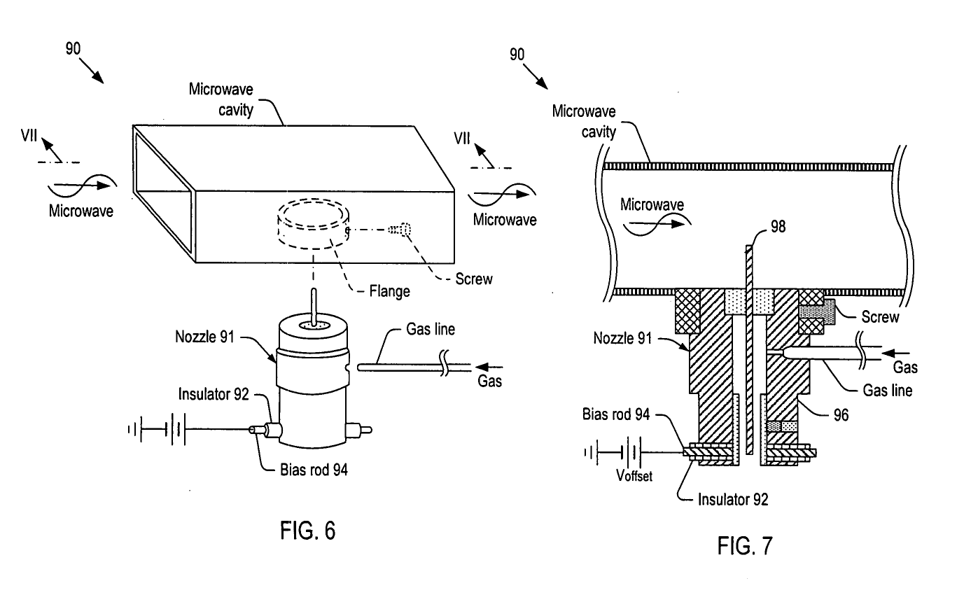

FIG. 6 shows an exploded view of a portion of a plasma generating system 90 in accordance with yet another embodiment of the present invention wherein like parts are the same as those of the embodiment of FIG. 3 and functioning is the same except as follows. FIG. 7 shows a side cross-sectional view of the portion of the plasma generating system 90, taken along the line VII-VII. As depicted, the system 90 is similar to the system 10 of FIG. 3, with the difference in the biasing mechanism. In the system 90, a nozzle 91 includes at least one insulator 92 secured to the housing/shield 96 and at least one bias rod 94 disposed in the insulator 92. The insulator 92 has a generally elongated hollow cylindrical shape and surrounds the bias rod 94 formed of conducting material and electrically biased by V_{offset} relative to the ground. As the function of the bias rod 94 is similar to that of the bias ring 42, the detailed description of the bias rod 94 is not repeated in the present document.

It is noted that the nozzle 91 includes two bias rods 94 disposed symmetrically with respect to the rod-shaped conductor 98. However, it should be apparent to those of ordinary skill that any other suitable number of bias rods can be used in the nozzle without deviating from the teachings of the present invention.

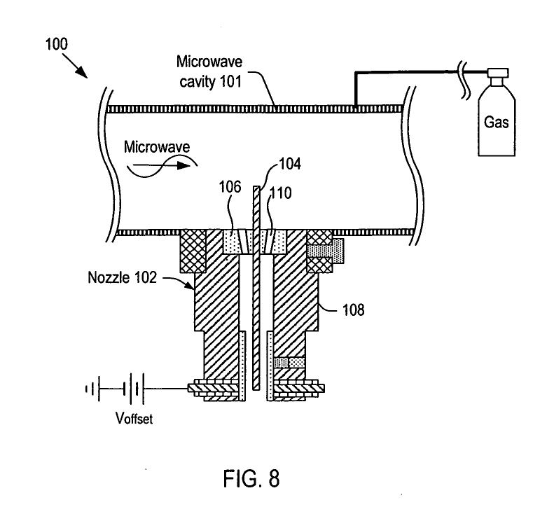

FIG. 8 shows a side cross-sectional view of a portion of a plasma generating system 100 in accordance with yet another embodiment of the present invention. As depicted, the system 100 is similar to the system 90 of FIG. 7, with the difference in the gas injection system. In the system 100, the gas is supplied through a microwave cavity 101 and through holes 110 formed in the electrical insulator 106, i.e., a housing/insulator 108 of a nozzle 102 does not have any gas injection hole. The through holes 110 may be angled relative to a longitudinal axis of the rod-shaped conductor 104 to impart a helical shaped flow direction around the rod-shaped conductor 104 to a gas passing along the through holes.

It is noted that each of the nozzles in FIGS. 5, 7, and 8 may have a mechanism to move the rod-shaped conductor in a vertical direction so that the field strength near the bottom tip of the rod-shaped conductor can be varied. More detailed information of the mechanism to move the rod-shaped conductor can be found in the previously referenced U.S. patent application Ser. No. 12/291,646, entitled “Plasma generating system having tunable plasma nozzle,” filed on Nov. 12, 2008.

It is also noted that the plasma generating systems depicted with reference to FIGS. 1-8 have only one nozzle. However, it should be apparent to those of ordinary skill in the art that more than one nozzle can be used in each system. Detailed descriptions of systems having multiple nozzles and methods for operating the systems can be found in U.S. Pat. No. 7,164,095 and U.S. Patent Publication Serial Nos. 2006/0021581, 2006/0021980, 2008/0017616 and 2008/0073202, which are herein incorporated by reference in their entirety.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims. Such modifications include substitution of components for components specifically identified herein, wherein the substitute component provides functional results which permit the overall functional operation of the present invention to be maintained. Such substitutions are intended to encompass presently known components and components yet to be developed which are accepted as replacements for components identified herein and which produce results compatible with operation of the present invention. Furthermore, while examples have been provided illustrating operation at certain frequencies, the present invention as defined in this disclosure and claims appended hereto is not considered limited to frequencies recited herein.

What is claimed is:

1. A plasma generating system, comprising:
at least one nozzle including:
a housing having a generally cylindrical space formed therein, the space defining a gas flow passageway, and the housing defining a nozzle exit;
a rod-shaped conductor disposed in the space and operative to transmit microwave energy along a surface thereof so that the microwave energy excites gas flowing through the space; and
a biasing device for providing a bias potential between the rod-shaped conductor and a bias electrode structure wherein the bias electrode structure is offset in potential from ground.

2. A plasma generating system as recited in claim 1, wherein the biasing device includes:
a bias ring disposed at the nozzle exit;
an insulator for electrically insulating the bias ring from the housing; and
a voltage potential supply for providing a potential offset from ground to said bias ring.

3. A plasma generating system as recited in claim 1, wherein the biasing device includes:
at least one insulator disposed in the housing and having a generally elongated hollow cylindrical shape;
at least one bias rod disposed in the insulator; and
a voltage potential supply for providing a potential offset from ground to said at least one bias rod.

4. A plasma generating system as recited in claim 1, wherein the housing includes a gas inlet hole.

5. A plasma generating system as recited in claim 1, wherein the housing is secured to a surface of a microwave cavity and a portion of the rod-shaped conductor extends into the microwave cavity to receive microwave energy.

6. A plasma generating system as recited in claim 5, further comprising an electrical insulator disposed in the space and adapted to hold the rod-shaped conductor relative to the housing.

7. A plasma generating system as recited in claim 6, wherein the electrical insulator includes at least one through hole angled with respect to a longitudinal axis of the rod-shaped conductor for imparting a helical shaped flow direction around the rod-shaped conductor to a gas passing along the through hole.

8. A plasma generating system, comprising:
a microwave generator for generating microwave energy;
a power supply connected to the microwave generator for providing power thereto;
a microwave cavity;
a waveguide operatively connected to the microwave cavity for transmitting the microwave energy from the microwave generator to the microwave cavity;
an isolator for dissipating microwave energy reflected from the microwave cavity; and
at least one nozzle coupled to the microwave cavity and including:
a housing having a generally cylindrical space formed therein, the space defining a gas flow passageway, and the housing defining a nozzle exit;
a rod-shaped conductor disposed in the space and having a portion extending into the microwave cavity for receiving microwave energy and operative to transmit microwave energy along a surface thereof so that the microwave energy transmitted along the surface excites gas flowing through the space; and
a biasing device for providing a bias potential between the rod-shaped conductor and a bias electrode structure wherein the bias electrode structure is offset in potential from ground.

9. A plasma generating system as recited in claim 8, wherein the biasing device includes:
a bias ring disposed at the nozzle exit;
an insulator for electrically insulating the bias ring from the housing; and
a voltage potential supply for providing a potential offset from ground to said bias ring.

10. A plasma generating system as recited in claim 8, wherein the biasing device includes:
at least one insulator disposed in the housing and having a generally elongated hollow cylindrical shape;
at least one bias rod disposed in the insulator; and
a voltage potential supply for providing a potential offset from ground to said at least one bias rod.

11. A plasma generating system as recited in claim 8, wherein the housing includes a gas inlet hole.

12. A plasma generating system as recited in claim 8, further comprising an electrical insulator disposed in the space and adapted to hold the rod-shaped conductor relative to the housing.

13. A plasma generating system as recited in claim 12, wherein the microwave cavity includes a wall forming a portion of a gas flow passageway.

14. A plasma generating system as recited in claim 13, wherein the electrical insulator includes at least one through hole angled with respect to a longitudinal axis of the rod-shaped conductor for imparting a helical shaped flow direction around the rod-shaped conductor to a gas passing along the through hole.
